(19) United States
(12) Patent Application Publication
(10) Pub. No.: US 2016/0088948 A1
(43) Pub. Date: Mar. 31, 2016

(54) SEAT DEVICE

(71) Applicant: SITAG AG, Sennwald (CH)

(72) Inventor: Yilmaz Boduk, Sennwald (CH)

(73) Assignee: SITAG AG, Sennwald (CH)

(21) Appl. No.: 14/867,913

(22) Filed: Sep. 28, 2015

(30) Foreign Application Priority Data
Sep. 26, 2014 (CH) 01459/14

(51) Int. Cl. A47C 7/62; G01G 19/52; G05B 19/19

(52) U.S. Cl. CPC A47C 7/62; G05B 19/195; G01G 19/52; G05B 2219/40175

(57) ABSTRACT

The invention relates to seat device, in particular an office chair, with a seat element, a backrest, a support frame on which the seat element and the backrest are disposed with a plurality of joints and sensors disposed on the seat device. The sensors detect physical and/or chemical properties generated by the seat device.

### CROSS REFERENCE TO RELATED APPLICATIONS

This application claims priority to Swiss Patent Application No. 01459/14 filed Sep. 26, 2014, the entirety of which is incorporated by this reference.

### FIELD OF THE INVENTION

The invention relates to a seat device according to the preamble of claim 1 and a retrofit kit for a seat device according to claim 11.

### STATE OF THE ART

Office chairs are known from the prior art whose seat and/or backrest surfaces are outfitted with pressure sensor mats.

In WO 2005/074754 is described a pressure sensor mat for improving the posture of a person seated on an office chair. A processor compares the data obtained from the mat with data stored in a memory. Poor posture of the seated person is thereby detected. Poor posture can be indicated to the seated person, for example, via a screen. However, the pressure sensors react only to the body weight of the seated person.

WO 03/001946 A1 discloses an office chair with sensors, the sensors of which are disposed on the office chair everywhere that the office chair comes into contact with a person seated on the office chair. The sensors detect ergonomic data of the person. The detected data is used by a processor to avoid ergonomic problems when the person sits on the office chair. If an ergonomically unfavorable sitting position is detected, the occupant is alerted visually or acoustically. The office chair can also be connected with an external computer via a wireless interface, whereby a seated person can communicate with the processor of the office chair, for example, to enter his or her body data and login credentials. The sensors are exclusively designed to detect the presence of a person, the position of the body of the person seated on the office chair and the movements thereof. The sensors may be pressure sensors, temperature sensors, position sensors or a camera.

U.S. 2011/0170945 describes a movable cinema chair which also comprises a weight sensor and a processor. Based on the sensor data, the degree of movement of the chair is determined. The sensor of the cinema chair is only designed to detect one characteristic of the moviegoer, for instance his or her weight.

### SUMMARY OF THE INVENTION

The present invention is a seat device which not only detects the position of the person seated thereon and the movement thereof, but rather which can be individualized.

### BRIEF DESCRIPTION OF THE DRAWINGS

FIG. 1 is a perspective side view of a seat device in accordance with the present invention.

FIG. 2 is a perspective side view of a kit for a seat device in accordance with the present invention.

FIG. 3 is a perspective side view of another embodiment of a seat device in accordance with the present invention

### DETAILED DESCRIPTION

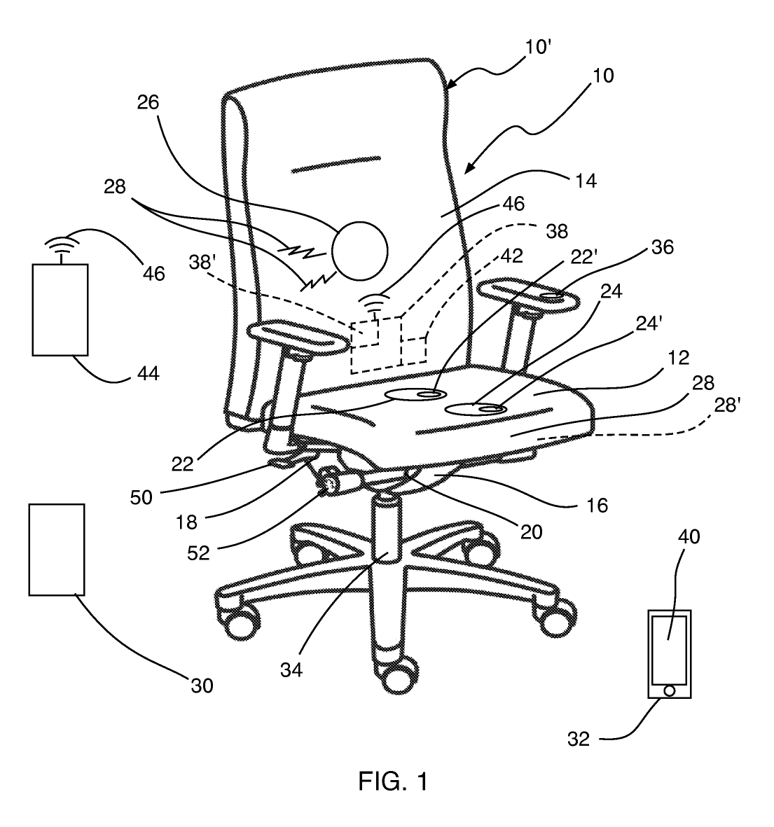

As shown in FIG. 1, the invention relates to a seat device 10 and in particular an office chair 10′. As is known from the prior art, the seat device 10 comprises a seat element 12 and a backrest 14. The seat element 12 and the backrest 14 are disposed on a support frame 16 via a plurality of joints 18 and 20. The seat element 12 and the backrest 14 can therefore experience tilting and/or linear movements if the user leans backwards.

According to the invention, the seat device 10 includes a plurality of sensors 22, 24 and 26 that detect physical and/or chemical properties generated by the seat device 10. The sensors 22, 24 and 26 can be used not only to detect the sitting position of a user, as is known from the prior art, but rather can transform into electrical signals 28 any sensorially detectable characteristic of the seat device 10 which is generated while the seat device 10 is in use or is vacant. It is thereby possible to assign the seat device 10 to a cost center 30 and to be informed at any time of the degree of wear or soiling of the seat device 10. It is also conceivable to use the sensor signals 28 to individualize and personalize the seat device 10, as is known from other technical consumer goods, such as smartphones 32.

In one embodiment, the sensors 22, 24 and 26 detect a use of the seat device 10, the manner of use, the intensity of use and the mechanical loads on the seat device 10 associated therewith. From these measured values, the degree of wear of the seat device 10 can be determined. Accordingly service intervals can also be displayed. It can be made transparent, for example, when the gas spring 34 or the joints 16 and 18 of an office chair 10′ require maintenance or replacement. It is also conceivable to be informed regarding the necessity of cleaning. This may be in particular demand in medical or hygienic workspaces.

The sensors 22, 24 and 26 suitably detect the wear and tear of wearing parts 28 installed on the seat device 10. As already stated in the last paragraph, necessary service of the seat device 10 can be made transparent by this feature of the invention. Necessary care needs can also be displayed, thereby preventing an expensive replacement of a wearing part.

In a further embodiment of the invention, the sensors 22, 24 and 28 detect an individual user of the seat device 10. The user identification can be implemented by means of pressure sensors 22′ and 24′ which detect the weight of the seat 12 and backrest 14 surfaces occupied by the user. Also conceivable is a fingerprint sensor 36 for identification of the user.

In a further embodiment, the seat device 10 comprises a processor 38 which detects and processes the sensor data 28. This feature of the invention makes it possible to visualize and further process the sensor data with an application software 40. By providing a processor 38, it is also conceivable to equip the seat device 10 with a measurement and control system 42 and to operate the seat device 10 with varying application software 40 (so-called “apps”).

In a further particularly preferred embodiment, the processor 38 can be integrated into a computer network 44, preferably via a radio link 46. A Wi-Fi or Bluetooth connection to the network 44 is preferably employed. The seat device 10 can thereby be made visible in a network, and various information can be visualized on the network 44. For operational management, it may be helpful, for example, to detect in a computer network 44 if and by whom the seat device 10 is used. Possible further uses of the network connection 46 of a seat device 10 are reservation of the seat device 10 or recording of a new application software on the processor 38. If the seat device 10 is assigned an external IP address, the seat device 10 according to the invention can also be accessed externally, for instance via a smartphone 32 with the appropriate application software 40.

In a further preferred embodiment of the invention, the processor 38 can be operated by an application software 38′, the captured data can be accessed via the application software 38′ and a user can be logged onto the processor by means of the application software 38′. This type of processor operation is familiar to and accordingly accepted by users from other consumer goods. Through an easy to use interface, all measurement and control tasks impacting the seat device 10 according to the invention may be easily achieved. The possibility of logging in strengthens the perception of the user that it is his or her own personal and individualized seating.

In a further embodiment of the invention, the power requirements of the sensors 22, 24 and 26 and the processor 38 can be generated at least partially through the movements of the seat device 10. In order to avoid the use of a battery, or to extend the life thereof, it is conceivable to use the inevitably occurring movements of the seat device 10 to generate electricity. This feature of the invention may have the positive effect upon the user of increased movement on the seat device 10. These movements include rolling, rotation back and forth on the seat 12, backward and forward tilting of the backrest 14 and standing up and sitting down on the seat 12.

It proves advantageous if the seat device 10 is adjustable by means of adjusting devices 50 and 52 which are connected to the processor 38. The processor 38 may therefore serve not only to retrieve measurement data, but also to control the adjusting devices 50 and 52. The seat device 10 according to the invention can be freely programmed and adapted precisely to the needs of a user. These adjustments can be saved and recalled at any time. A seat device 10 which is used by different users can thus be quickly transformed to the respectively saved settings. The configuration and adjustment can occur by means of the application software 38′ and can optionally also occur manually directly on the seat device 10.

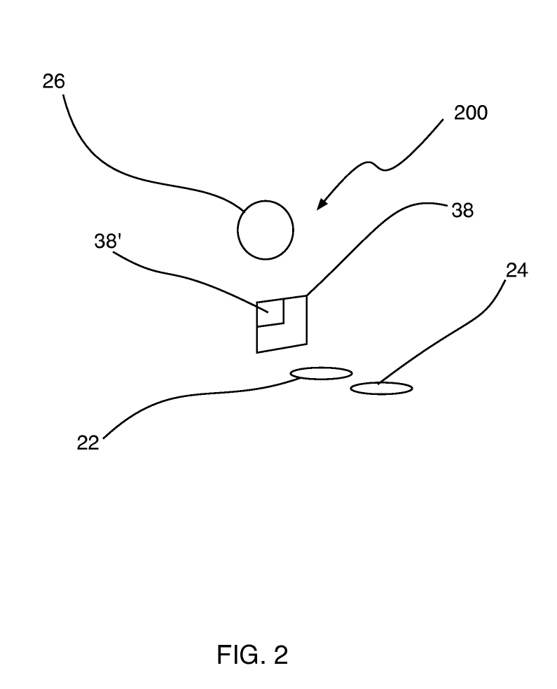

As shown in FIG. 2, a further aspect of the invention relates to a retrofit kit 200 for a seat device, comprising the above-described plurality of sensors 22, 24 and 26, a processor 38 and an application software 38′. The retrofit kit 100 makes it possible to retrofit a data collection on any existing seat.

Referring again to FIG. 1, another aspect of the invention relates to a system of a plurality of seat devices 10 according to the invention, which has an IP address and is connected to a computer network 44. The advantages resulting therefrom have already been mentioned above.

The plurality of seat devices 10 is functionally connected to the network 44 with a wireless network connection 46. The individual seat devices 10 are hereby undisturbed in their ability to move through the connection to the network 44.

In another embodiment of the invention, the plurality of seat devices 10 can be visualized in the computer network 44 by means of a software application, collected data from every seat device 10 can be retrieved and each seat device 10 is accessible and controllable. Thus, each seat device 10 connected to the network 44 is accessible worldwide. This is particularly important for remote maintenance or remote access.

From the above paragraph it follows that a seat device 10 of the network 44 can be adjusted via the network 44 to the settings of a user. Thus, for example, conference chairs or waiting chairs and general seating which is used by multiple users can be adjusted to the user in advance.

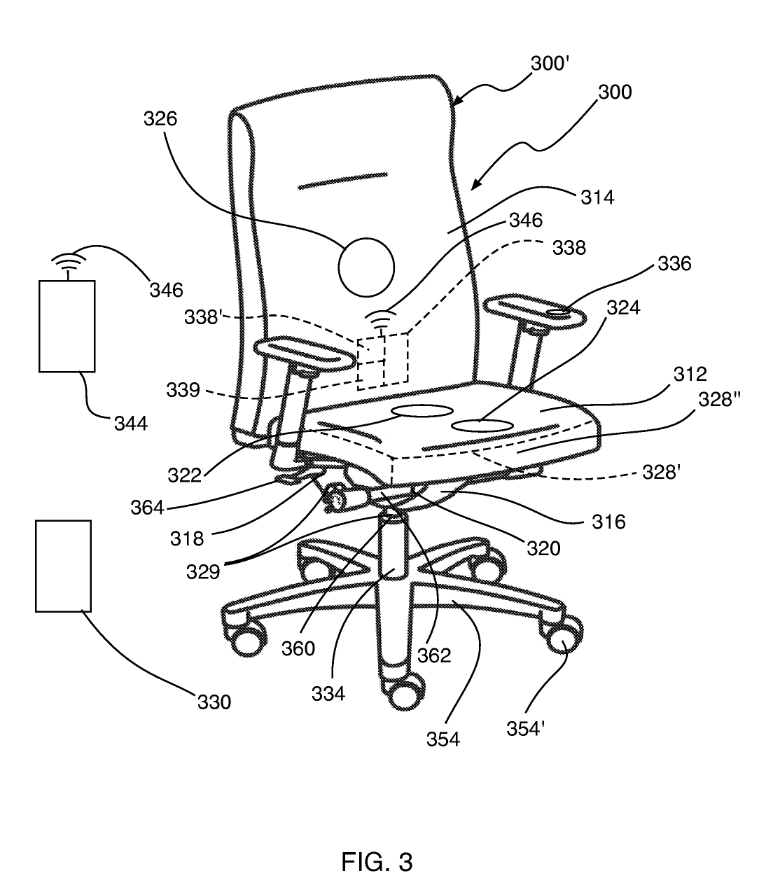

As further shown in FIG. 3, the present invention relates to a seat device 300, such as an office chair 300′. The invention takes into account the increased demands for increased personalization and individualization of consumer goods. The invention also takes into account the trend for companies to centrally detect and manage the office items, such as office chairs, desks or computers, used by their employees.

An office chair 300′ typically has moving parts, for example a gas spring 334 which keeps a support frame 316 cushioned at a distance from a roller base 354. Further moving parts of an office chair are the joints 318 and 320, which enable the backrest 314 and the seat element 312 to move relative to the support frame 316 of the office chair 310′. The rollers 354′ and the roller base 354 also number among the movable parts. These moving parts are inevitably subjected to constant wear. The foam 328′ and the cover 328″ of the backrest 314 and the seat element 312 are also subjected to wear and tear.

The movements of the previously described parts can be detected by motion sensors 329. The data detected by the motion sensors 329 is passed to a processor 338, where it is stored and compared with data stored in a memory 339. However, the use of sensors in an office chair 310′ is not limited to motion sensors 329. Also conceivable is the use of pressure sensors 322, 324 and 326 for detecting the weight and movements of a user or fingerprint sensors 336 for user login.

The processor 338 connected to the sensors 322, 324, 326 and 329 can be integrated into a computer network 344. This is easy to achieve by means of conventional wireless connection technologies 346 such as WLAN (Wi-Fi).

With an application software 338′ adapted to the detected data, the data stored in the processor 338 can be retrieved, analyzed and read in a computer program. It is thus possible to display the service life and load factor (depending on the weight of the user) of the moving parts and to detect a necessity of exchange for spare parts. The evaluation of the measured data can provide many further results. Conceivable is the detection of sitting, use of the office chair 300′ per unit of time, display of necessary cleaning, etc. Logistical data can also be thus detected. For example, the maintenance costs of the office chair 300′ to the cost center 330 can be calculated for an employee. It may also prove to be practical if it can be seen on the network 344 if a chair 300 is in use currently or in the future. It is thus possible to reserve chairs in a conference room online, or it is visible from the network 344 whether or not an employee is in his or her seat.

In a further embodiment, the office chair 300′ can also comprise electrical adjusting devices 360, 362 and 364. It is thus conceivable that the office chair 300′ can be adjusted by means of application software 338′. It is also conceivable that an office chair 300′ which is used by multiple users automatically adjusts itself to stored user settings. This can occur through logging in to the application software 338′ or through a fingerprint sensor 336.

1-15. (canceled)

16. A seat device comprising:
a seat element;
a backrest;
a support frame to which the seat element and the backrest are coupled with a plurality of joints; and
a plurality of sensors disposed on the seat device, the plurality of sensors configured for detecting at least one of a physical or chemical property of the seat device.

17. The seat device of claim 1, wherein the plurality of sensors detect a use of the seat device, a manner of use, an intensity of use and a mechanical load on the seat device associated therewith.

18. The seat device of claim 1, wherein the plurality of sensors detect wear and tear of wearing parts installed on the seat device.

19. The seat device of claim 1, wherein the sensors recognize an individual user of the seat device.

20. The seat device of claim 1, wherein the seat device comprises a processor configured to process sensor data from the plurality of sensors.

21. The seat device of claim 20, wherein the processor can be integrated into a computer network via a radio link.

22. The seat device of any one of claims 20, wherein the processor can be operated by application software, the sensor data can be accessed via the application software and a user can be logged onto the processor by the application software.

23. The seat device of claim 20, wherein power requirements of the plurality of sensors and the processor can be generated at least partially through the movements of the seat device.

24. The seat device of claim 20, wherein the seat device is adjustable by a plurality of adjusting devices connected to the processor.

25. The seat device of claim 24, wherein the plurality of adjusting devices can be controlled through application software.

26. The seat device of claim 16, further comprising a plurality of seat devices, wherein each of the plurality of seat devices has an IP address and is connected to a computer network.

27. The seat device of claim 26, wherein the plurality of seat devices is connected to the computer network with a wireless network connection.

28. The seat device of claim 26, wherein the plurality of seat devices can be visualized in the computer network with a software application, and collected data from each of the plurality of seat devices can be retrieved and each of the plurality of seat devices is accessible and controllable.

29. The seat device of claim 26, wherein each of the plurality of seat devices on the computer network can be adjusted via the network to the settings of a user.

30. A retrofit kit for a seat device, comprising:
a plurality of sensors configured to be disposed on a seat device, the plurality of sensors configured for detecting at least one of a physical or chemical property of the seat device; and
a processor configured to process sensor data from the plurality of sensors.
